(19) United States
(12) Patent Application Publication
(10) Pub. No.: US 2021/0269001 A1
(43) Pub. Date: Sep. 2, 2021

(54) ELECTRIC BRAKE APPARATUS, ELECTRIC BRAKE CONTROL APPARATUS, AND BRAKE CONTROL APPARATUS

(71) Applicant: HITACHI AUTOMOTIVE SYSTEMS, LTD., Ibaraki (JP)

(72) Inventors: Kenji SUZUKI, Ibaraki (JP); Hirotake SUZUKI, Ibaraki (JP); Kimio NISHINO, Ibaraki (JP)

(21) Appl. No.: 17/253,905

(22) PCT Filed: Jun. 18, 2019
(86) PCT No.: PCT/JP2019/023998

§ 371 Date: Dec. 18, 2020

(30) Foreign Application Priority Data
Jun. 27, 2018 (JP) 2018-121835

(51) Int. Cl. B60T 8/32; B60T 13/74; B60T 1/06; B60T 17/18; B60T 7/12

(52) U.S. Cl. CPC B60T 8/321; B60T 13/746; B60T 1/065; B60T 13/58; B60T 7/12; B60T 2240/00; B60T 2250/00; B60T 17/18

(57) ABSTRACT

Wheel speed sensors detect wheel speeds of a plurality of wheels (i.e., a wheel speed of a front left wheel, a wheel speed of a front right wheel, a wheel speed of a rear left wheel, and a wheel speed of a rear right wheel), respectively. A braking control apparatus controls driving of an electric motor. The braking control apparatus drives the electric motor to increase a braking force when the wheel speed sensors detect wheel speed pulses from at least two wheels after a start to maintain the braking force.

### TECHNICAL FIELD

The present invention relates to an electric brake apparatus that applies a braking force to a vehicle such as an automobile, an electric brake control apparatus, and a brake control apparatus.

### BACKGROUND ART

There is known a brake apparatus that applies a braking force based on driving (a rotation) of an electric motor (an electrically-driven motor), for example, when stopping or parking a vehicle, as an electric brake apparatus mounted on a vehicle such as an automobile (PTL 1). When detecting a vibration accompanying a vehicle's unexpected start to move while applying the electric parking brake (maintaining the braking force), the brake apparatus discussed in PTL 1 increases a thrust force until the vibration disappears.

### CITATION LIST

### Patent Literature

PTL 1: Japanese Patent Application Public Disclosure No. 2013-132935

### SUMMARY OF INVENTION

### Technical Problem

However, this brake apparatus may erroneously determine that the vehicle has started to move despite the fact that the vehicle can be actually kept in the parked state because determining (detecting) the vehicle's unexpected start to move based on the vibration of the wheel cylinder. For example, the brake apparatus may make the erroneous determination by mistaking a vibration accompanying a user's (passenger's) getting into/out of the vehicle, loading/unloading the baggage, or the like as the vibration accompanying the vehicle's start to move. As a result, the brake apparatus may end up excessively applying the braking force, and cause an increase in time taken to complete the release of the brake when releasing the electric brake next time (releasing the braking force) (a reduction in the responsiveness).

An object of the present invention is to provide an electric brake apparatus, an electric brake control apparatus, and a brake control apparatus capable of accurately detecting (determining) a vehicle's unexpected start to move and applying a required braking force.

### SOLUTION TO PROBLEM

According to one aspect of the present invention, an electric brake apparatus includes at least one wheel speed detection portion(s) configured to detect wheel speeds of a plurality of wheels, respectively, an electric motor configured to drive an electric mechanism configured to apply a braking force to a vehicle and also maintain this braking force, and a control apparatus configured to control driving of the electric motor. The control apparatus drives the electric motor to increase the braking force when the wheel speed detection portion(s) detect(s) wheel speed pulses from at least two wheels after a start to maintain the braking force.

According to one aspect of the present invention, an electric brake control apparatus acquires wheel speed information from a plurality of wheels and controls driving of an electric motor configured to drive an electric mechanism. The electric mechanism is configured to apply a braking force to a vehicle and also maintain this braking force. The electric brake control apparatus drives the electric motor to increase the braking force when acquiring the wheel speed information regarding at least two wheels after a start to maintain the braking force.

According to one aspect of the present invention, a brake control apparatus receives wheel speed information acquired from a plurality of wheels from a vehicle body-side control apparatus, and transmits an instruction to drive an electric mechanism to the vehicle body-side control apparatus. The electric mechanism is configured to apply a braking force to a vehicle and also maintain this braking force. The brake control apparatus transmits the instruction to drive the electric motor so as to increase the braking force to the vehicle body-side control apparatus when receiving the wheel speed information resulting from detecting wheel speeds regarding a plurality of wheels from the vehicle body-side control apparatus after transmitting information indicating a transition of the electric mechanism to a braking force maintenance state to the vehicle body-side control apparatus.

### Advantageous Effects of Invention

The electric brake apparatus, the electric brake control apparatus, and the brake control apparatus according to the one aspects of the present invention can accurately detect (determine) the vehicle's unexpected start to move and apply the required braking force.

### BRIEF DESCRIPTION OF DRAWINGS

FIG. 1 is a conceptual diagram of a vehicle on which an electric brake apparatus according to a first embodiment is mounted.

FIG. 2 is a vertical cross-sectional view illustrating a disk brake equipped with an electric parking brake function that is mounted on a rear wheel side in FIG. 1 in an enlarged manner.

FIG. 3 is a block diagram illustrating a braking control apparatus in FIG. 1 together with the disk brake, a hydraulic pressure supply apparatus, and the like.

FIG. 4 is a flowchart illustrating control processing performed by the braking control apparatus in FIG. 1.

FIG. 5 is a conceptual diagram of a vehicle on which an electric brake apparatus according to a second embodiment is mounted.

FIG. 6 is a block diagram illustrating a parking brake control apparatus in FIG. 5 together with the rear wheel-side disk brake and the like.

FIG. 7 is a block diagram illustrating a braking control apparatus (or a parking brake control apparatus) according to a third embodiment.

### DESCRIPTION OF EMBODIMENTS

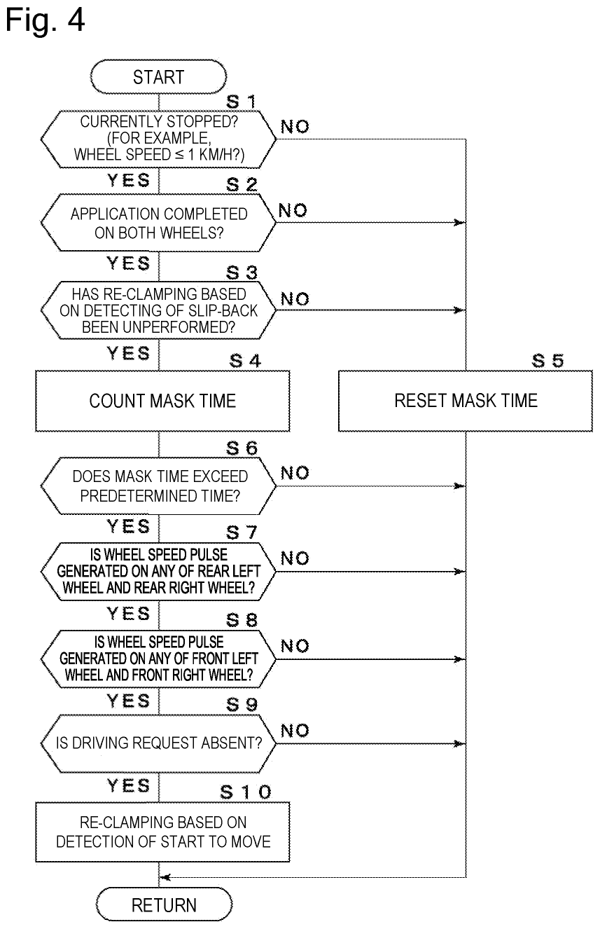

In the following description, an electric brake apparatus, an electric brake control apparatus, and a brake control apparatus according to embodiments will be described based on an example when they are mounted on a four-wheeled automobile with reference to the accompanying drawings. Each of steps in a flowchart illustrated in FIG. 4 will be represented by the symbol “S” (for example, assume that “S1” represents step 1).

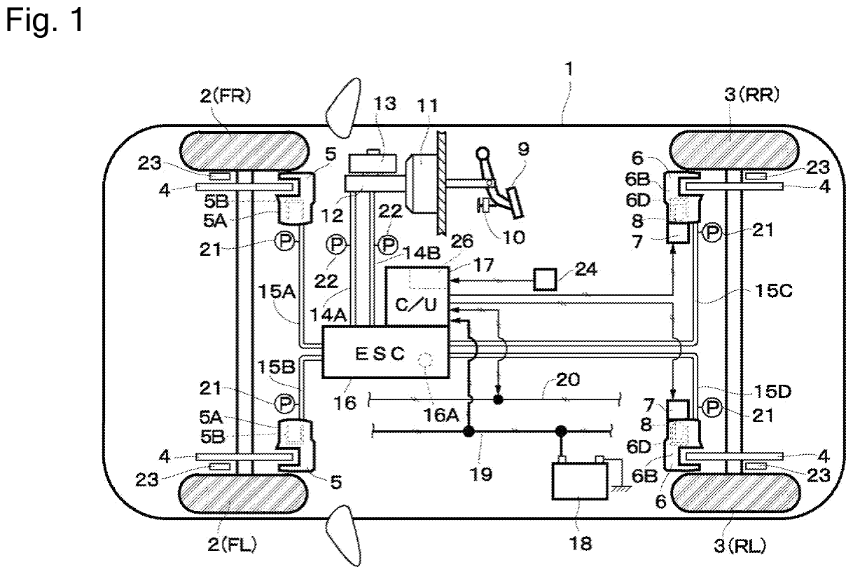

FIGS. 1 to 4 illustrate a first embodiment. In FIG. 1, four wheels in total including, for example, front left and right wheels 2 (FL and FR) and rear left and right wheels 3 (RL and RR) are mounted under a vehicle body 1, which forms a main structure of a vehicle (on a road surface side). The wheels (each of the front wheels 2 and each of the rear wheels 3) form the vehicle together with the vehicle body 1. A brake system for applying a braking force is mounted on the vehicle. In the following description, the brake system of the vehicle will be described.

A disk rotor 4 is provided on each of the front wheels 2 and the rear wheels 3. The disk rotor 4 serves as a braking target member (a rotational member) that rotates together with each of the wheels (each of the front wheels 2 and each of the rear wheels 3). The disk rotor 4 for the front wheel 2 is subjected to a braking force by a front wheel-side disk brake 5, which is a hydraulic disk brake. The disk rotor 4 for the rear wheel 3 is subjected to a braking force by a rear wheel-side disk brake 6, which is a hydraulic disk brake equipped with an electric parking brake function.

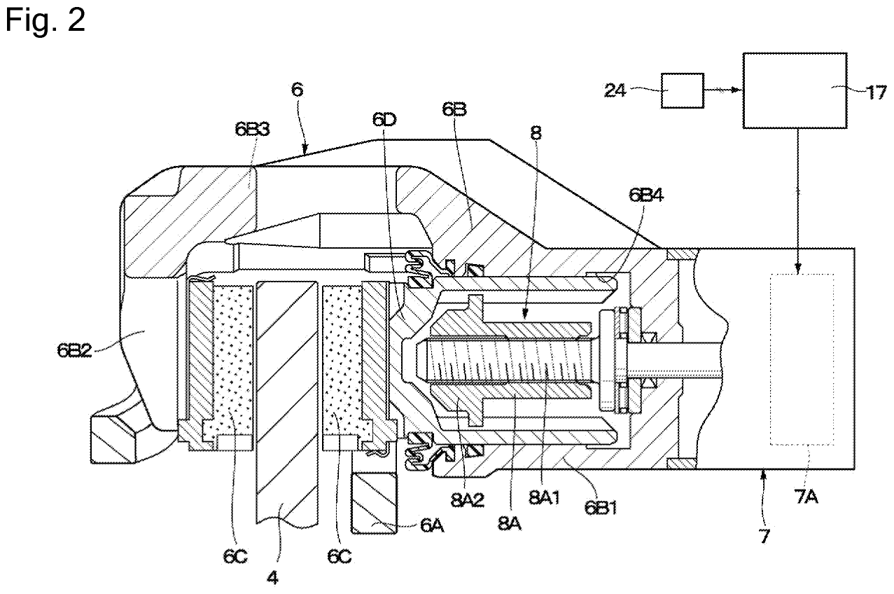

A pair (set) of rear wheel-side disk brakes 6 provided in correspondence with the rear left and right wheels 3, respectively, is a hydraulic brake mechanism (a hydraulic brake) that applies a braking force by pressing brake pads 6C (refer to FIG. 2) against the disk rotor 4 with use of a hydraulic pressure. As illustrated in FIG. 2, each of the rear wheel-side disk brakes 6 includes, for example, a mount member 6A called a carrier, a caliper 6B as a wheel cylinder, a pair of brake pads 6C as braking members (friction members or friction pads), and a piston 6D as a pressing member. In this case, the caliper 6B and the piston 6D form a cylinder mechanism, more specifically, a cylinder mechanism that is moved by the hydraulic pressure to press the brake pads 6C against the disk rotor 4.

The mount member 6A is fixed to a non-rotatable portion of the vehicle, and is formed so as to extend across over the outer peripheral side of the disk rotor 4. The caliper 6B is provided on the mount member 6A movably in the axial direction of the disk 4. The caliper 6B includes a cylinder main body portion 6B1, a claw portion 6B2, and a bridge portion 6B3 connecting them. A cylinder (a cylinder hole) 6B4 is provided in the cylinder main body portion 6B1, and the piston 6D is fittedly inserted in the cylinder 6B4. The brake pads 6C are movably attached to the mount member 6A, and are disposed so as to be able to abut against the disk rotor 4. The piston 6D presses the brake pad 6C against the disk rotor 4.

Then, the caliper 6B thrusts the brake pad 6C by the piston 6D according to supply (an application) of the hydraulic pressure (a brake hydraulic pressure) into the cylinder 6B4 based on an operation performed on a brake pedal 9 or the like. At this time, the brake pads 6C are pressed against the both surfaces of the disk rotor 4 by the claw portion 6B2 and the piston 6D of the caliper 6B. As a result, a braking force is applied to the rear wheel 3 rotating together with the disk rotor 4.

Further, the rear wheel-side disk brake 6 includes an electric actuator 7 and a rotation-liner motion conversion mechanism 8. The electric actuator 7 includes an electric motor 7A as an electrically-driven motor, and a speed reducer (not illustrated) that slows down the rotation of this electric motor 7A. The electric motor 7A serves as a thrust source (a driving source) for thrusting the piston 6D. The rotation-linear motion conversion mechanism 8 forms a holding mechanism (a pressing member holding mechanism) that maintains the force pressing the brake pads 6C.

In this case, the rotation-linear motion conversion mechanism 8 includes a rotation-linear motion member 8A. The rotation-linear motion member 8A converts a rotation of the electric motor 7A into an axial displacement (a linear displacement) of the piston 6D and also thrusts this piston 6D. The rotation-linear motion member 8A includes, for example, a screw member 8A1 and a linear motion member 8A2. The screw member 8A1 is made of a rod-like member with a male screw formed thereon. The linear motion member 8A2 serves as a thrust member with a female screw hole formed on the inner peripheral side thereof. In other words, the rotation-linear motion conversion mechanism 8 is realized by a spindle nut mechanism.

The rotation-linear motion conversion mechanism 8 converts the rotation of the electric motor 7A into the axial displacement of the piston 6D, and also holds the piston 6D thrust by the electric motor 7A. More specifically, the rotation-linear motion conversion mechanism 8 provides a thrust force to the piston 6D by the electric motor 7A, thrusts the brake pad 6C by this piston 6D to press the disk rotor 4, and maintains the thrust force on this piston 6D.

The rotation-linear motion conversion mechanism 8 forms an electric mechanism of the electric parking brake together with the electric motor 7A. The electric mechanism converts the rotational force of the electric motor 7A into the thrust force via the speed reducer and the rotation-linear motion conversion mechanism 8 to apply the thrust force to the piston 6D pressing the brake pad 6C, and maintains or releases the braking force. In other words, the electric mechanism thrusts the piston 6D to apply the braking force to the vehicle, and maintains this braking force. The electric motor 7A drives the electric mechanism. The electric motor 7A forms the electric brake apparatus together with a braking control apparatus 17 and wheel speed sensors 23, which will be described below.

The rear wheel-side disk brake 6 thrusts the piston 6D with the use of the brake hydraulic pressure generated based on, for example, the operation performed on the brake pedal 9 to press the disk rotor 4 with the brake pads 6C, thereby applying the braking force to the wheel (the rear wheel 3) and thus the vehicle. In addition thereto, the rear wheel-side disk brake 6 thrusts the piston 6D with use of the electric motor 7A via the rotation-linear motion conversion mechanism 8 according to an actuation request based on a signal from a parking brake switch 24, thereby applying a braking force (a parking brake or an auxiliary brake when necessary) to the vehicle, as will be described below.

In other words, the rear wheel-side disk brake 6 presses the brake pads 6C against the disk rotor 4 by driving the electric motor 7A and thrusting the piston 6D with the aid of the rotation-linear motion member 8A. In this case, the rear wheel-side disk brake 6 is configured to be able to maintain the braking on the vehicle by thrusting the piston 6D with use of the electric motor 7A according to a parking brake request signal (an application request signal), which serves as an application request for providing the parking brake (the brake used to park the vehicle). Along therewith, the rear wheel-side disk brake 6 is configured to be able to brake the vehicle based on the supply of the hydraulic pressure from a hydraulic pressure source (a master cylinder 12, which will be described below, or the hydraulic pressure supply apparatus 16 as necessary) according to the operation performed on the brake pedal 9.

In this manner, the rear wheel-side disk brake 6 includes the rotation-linear motion conversion mechanism 8, which presses the brake pads 6C against the disk rotor 4 with use of the electric motor 7A and maintains the force pressing this brake pads 6C, and is also configured to be able to press the brake pads 6C against the disk rotor 4 with use of the hydraulic pressure that is added separately from the pressing using the electric motor 7A.

On the other hand, a pair (a set) of front wheel-side disk brakes 5 provided in correspondence with the front left and right wheels 2, respectively, is configured in an approximately similar manner to the rear wheel-side disk brakes 6, except for the mechanism relating to the operation of the parking brake. More specifically, as illustrated in FIG. 1, each of the front wheel-side disk brakes 5 includes a mount member (not illustrated), a caliper 5A, brake pads (not illustrated), a piston 5B, and the like, but does not include the electric actuator 7 (the electric motor 7A), the rotation-linear motion conversion mechanism 8, and the like for actuating and releasing the parking brake. However, the front wheel-side disk brake 5 is similar to the rear wheel-side disk brake 6 in terms of thrusting the piston 5B by the hydraulic pressure generated based on, for example, the operation performed on the brake pedal 9 to apply the braking force to the wheel (the front wheel 2) and thus the vehicle. In other words, the front wheel-side disk brake 5 is a hydraulic brake mechanism (a hydraulic brake) that applies the braking force by pressing the brake pads against the disk rotor 4 with use of the hydraulic pressure.

The front wheel-side disk brake 5 may be configured as a disk brake equipped with the electric parking brake function similarly to the rear wheel-side disk brake 6. Further, in the embodiment, the hydraulic disk brake 6 including the electric motor 7A is used as the electric brake mechanism (the electric parking brake). However, the electric brake mechanism is not limited thereto, and examples of another brake apparatus usable as the electric brake mechanism include an electric disk brake including an electric caliper, an electric drum brake that applies the braking force by pressing a shoe against a drum with use of an electric actuator, a disk brake equipped with an electric drum-type parking brake, and a cable puller-type electric parking brake that actuates the application of the parking brake by pulling a cable with use of an electric motor. In other words, various types of electric brake mechanisms can be used as the electric brake mechanism, as long as the used mechanism is configured to be able to press (thrust) the friction member (the pad or the shoe) against the rotational member (the rotor or the drum) based on the driving of the electric motor (the electric actuator), and maintain and release this pressing force.

The brake pedal 9 is provided on the dashboard side of the vehicle body 1. The brake pedal 9 is operated by being pressed by a driver (an operator) at the time of the operation of braking the vehicle. Each of the disk brakes 5 and 6 applies and releases the braking force as a regular brake (a service brake) based on the operation performed on the brake pedal 9. A brake operation detection sensor (a brake sensor) 10, such as a brake lamp switch, a pedal switch (a brake switch), and a pedal stroke sensor, is provided at the brake pedal 9.

The brake operation detection sensor 10 is connected to the braking control apparatus 17. The brake operation detection sensor 10 detects the presence or absence of the operation of pressing the brake pedal 9 or an operation amount thereof, and outputs a detection signal thereof to the braking control apparatus 17. The detection signal of the brake operation detection sensor 10 is transmitted via, for example, a vehicle data bus 20 (output to another control apparatus).

The operation of pressing the brake pedal 9 is transmitted to a master cylinder 12, which functions as an oil pressure source (a hydraulic pressure source), via a booster 11. The booster 11 is configured as a negative-pressure booster (an atmospheric-pressure booster) or an electric booster (an electrically-driven booster) provided between the brake pedal 9 and the master cylinder 12. The booster 11 powers up the pressing force and transmits it to the master cylinder 12 at the time of the operation of pressing the brake pedal 9.

At this time, the master cylinder 12 generates a hydraulic pressure with use of brake fluid supplied (replenished) from a master reservoir 13. The master reservoir 13 serves as a hydraulic fluid tank that contains the brake fluid therein. The mechanism for generating the hydraulic pressure by the brake pedal 9 is not limited to the above-described configuration, and may be a mechanism that generates the hydraulic pressure according to the operation performed on the brake pedal 9 such as a brake-by-wire type mechanism.

The hydraulic pressure generated in the master cylinder 12 is transmitted to the hydraulic pressure supply apparatus 16 (hereinafter referred to as an ESC 16) via, for example, a pair of cylinder-side hydraulic pressure pipes 14A and 14B. The ESC 16 is disposed between each of the disk brakes 5 and 6 and the master cylinder 12. The ESC 16 distributes and supplies the hydraulic pressure output from the master cylinder 12 via the cylinder-side hydraulic pressure pipes 14A and 14B to each of the disk brakes 5 and 6 via brake-side pipe portions 15A, 15B, 15C, and 15D. In other words, the ESC 16 serves to supply the hydraulic pressure (the brake hydraulic pressure) according to the operation performed on the brake pedal 9 to the disk brake 5 or 6 (the caliper 5A or 6B) mounted on each of the wheels (each of the front wheels 2 and each of the rear wheels 3). By this operation, the ESC 16 can apply the braking force to each of the wheels (each of the front wheels 2 and each of the rear wheels 3) independently of one another.

Now, the ESC 16 is a hydraulic pressure control apparatus that controls the hydraulic pressure of the hydraulic brake (the front wheel-side disk brake 5 and the rear wheel-side disk brake 6). For fulfilling this function, the ESC 16 includes a plurality of control valves and a hydraulic pressure pump (neither of them is illustrated), an electric motor 16A, and a reservoir for controlling the hydraulic pressure (not illustrated). The hydraulic pressure pump pressurizes the brake hydraulic pressure. The electric motor 16A drives this hydraulic pressure pump. The reservoir for controlling the hydraulic pressure temporarily stores extra brake fluid therein. Each of the control valves and the electric motor 16A of the ESC 16 are connected to the braking control apparatus 17, and the ESC 16 includes the braking control apparatus 17.

The opening/closing of each of the control valves and the driving of the electric motor 16A of the ESC 16 are controlled by the braking control apparatus 17. In other words, the braking control apparatus 17 is an ESC control apparatus (an ECU for the ESC) that controls the ESC 16. As will be described below, in addition to being the ESC control apparatus that controls the ESC 16, the braking control apparatus 17 is also a parking brake control apparatus (an ECU for the parking brake) that controls the rear wheel-side disk brake 6 (the electric motor 7A thereof).

In other words, in the first embodiment, the ESC control apparatus (the control unit for the ESC) and the parking brake control apparatus (the control unit for the parking brake) are formed by one braking control apparatus 17. As will be described below, the braking control apparatus 17 includes a microcomputer, and electrically controls the driving of the ESC 16 (the solenoid of each of the control valves and the electric motor 16A thereof). In addition thereto, the braking control apparatus 17 electrically controls the driving of the electric motor 7A of the rear wheel-side disk brake 6. The configuration of the braking control apparatus 17 will be described in detail below.

The braking control apparatus 17 individually controls the driving of each of the control valves (the solenoid thereof) of the ESC 16 and the electric motor 16A for the hydraulic pressure pump. Due to this control, the braking control apparatus 17 performs control of reducing, maintaining, increasing, or pressurizing the brake hydraulic pressure (a wheel cylinder hydraulic pressure) to supply to each of the disk brakes 5 and 6 via the brake-side pipe portions 15A to 15D for each of the disk brakes 5 and 6 individually.

In this case, the braking control apparatus 17 can perform, for example, the following kinds of control (1) to (8) by controlling the actuation of the ESC 16. (1) Braking force distribution control of appropriately distributing the braking force to each of the wheels 2 and 3 according to a vertical load and the like when the vehicle is braked. (2) Anti-lock brake control (hydraulic ABS control) of preventing each of the wheels 2 and 3 from being locked (slipped) by automatically adjusting the braking force applied to each of the wheels 2 and 3 when the vehicle is braked. (3) Vehicle stabilization control of stabilizing a behavior of the vehicle by preventing or reducing understeer and oversteer while detecting a sideslip of each of the wheels 2 and 3 when the vehicle is running and appropriately automatically controlling the braking force to apply to each of the wheels 2 and 3 regardless of the operation amount of the brake pedal 9. (4) Hill start aid control of aiding a start by maintaining a braked state on a slope (especially, an ascending slope). (5) Traction control of preventing each of the wheels 2 and 3 from idly spinning, for example, when the vehicle starts running. (6) Vehicle following control of maintaining a predetermined distance to a preceding vehicle. (7) Traffic lane departure avoidance control of keeping the vehicle located within a traffic lane. (8) Obstacle avoidance control of avoiding a collision with an obstacle placed in a direction in which the vehicle is traveling (autonomous brake control or collision damage reduction brake control).

The ESC 16 directly supplies the hydraulic pressure generated in the master cylinder 12 to the disk brakes 5 and 6 (the calipers 5A and 6B thereof) at the time of a normal operation in response to the brake operation performed by the driver. On the other hand, for example, when performing the anti-lock brake control or the like, the ESC 16 maintains the hydraulic pressures in the disk brakes 5 and 6 by closing a control valve for the pressure increase. When reducing the hydraulic pressures in the wheel disk brakes 5 and 6, the ESC 16 discharges the hydraulic pressures in the disk brakes 5 and 6 so as to release them to the reservoir for controlling the hydraulic pressure by opening a control valve for the pressure reduction.

Further, when increasing or pressurizing the hydraulic pressures to supply to the disk brakes 5 and 6 to perform, for example, the stabilization control (sideslip prevention control) while the vehicle is running, the ESC 16 actuates the hydraulic pressure pump by the electric motor 16A with a control valve for the supply closed, thereby supplying the brake fluid discharged from this hydraulic pressure pump to the disk brakes 5 and 6. At this time, the brake fluid in the master reservoir 13 is supplied from the master cylinder 12 side toward an intake side of the hydraulic pressure pump.

Electric power from a battery 18 (or a generator driven by an engine), which serves as a vehicle electric power source, is supplied to the braking control apparatus 17 via an electric power source line 19. As illustrated in FIG. 1, the braking control apparatus 17 is connected to the vehicle data bus 20. Instead of the ESC 16, a known ABS unit can also be used. Alternatively, the master cylinder 12 and the brake-side pipe portions 15A to 15D can also be directly connected to each other without the provision of the ESC 16 (i.e., with the ESC 16 omitted).

The vehicle data bus 20 forms a CAN (Controller Area Network) as a serial communication portion mounted on the vehicle body 1. A large number of electronic apparatuses mounted on the vehicle (for example, various kinds of ECUs including the braking control apparatus 17 and the like) carry out multiplex communication with one another via the vehicle data bus 20. In this case, examples of vehicle information transmitted to the vehicle data bus 20 include information (vehicle information) based on detection signals (output signals) from the brake operation detection sensor 10, a W/C pressure sensor 21 that detects the wheel cylinder pressure, an M/C pressure sensor 22 that detects the master cylinder pressure, an ignition switch, a safety belt sensor, a door lock sensor, a door opening sensor, a seat occupancy sensor, a vehicle speed sensor, a steering angle sensor, an accelerator sensor (an accelerator operation sensor), a throttle sensor, an engine rotation sensor, a stereo camera, a millimeter-wave radar, a slope sensor (an inclination sensor), a gearshift sensor (transmission data), an acceleration sensor (a G sensor), a pitch sensor that detects a motion of the vehicle in a pitch direction, and the like.

Further examples of the vehicle information transmitted to the vehicle data bus 20 also include detection signals (information) from the wheel speed sensors 23, which detect the respective speeds (wheel speeds) of the wheels (the front left wheel 2, the front right wheel 2, the rear left wheel 3, and the rear right wheel 3). As illustrated in FIG. 1, four wheel speed sensors 23 in total are provided in correspondence with the front left wheel 2, the front right wheel 2, the rear left wheel 3, and the rear right wheel 3, respectively. Each of the wheel speed sensors 23 can be realized by a rotational speed sensor such as a magnetic encoder.

The wheel speed sensors 23 output signals (wheel speed pulses) according to the speeds (the wheel speeds) of the wheels 2 and 3 as the detection signals. For example, the wheel speed sensors 23 output the wheel speed pulses to the braking control apparatus 17 via the vehicle data bus 20. The detection signals of the wheel speed sensors 23 are used to control the ESC 16 and the electric parking brake by the braking control apparatus 17 as the information indicating the respective wheel speeds of the wheels 2 and 3 (the wheel speed information). A large number of electronic apparatuses (the various kinds of ECUs) mounted on the vehicle can acquire various kinds of vehicle information (signals) including the wheel speed information via the vehicle data bus 20. The wheel speed sensors 23 correspond to wheel speed detection portions that detect wheel speeds of a plurality of wheels (i.e., the wheel speed of the front left wheel 2, the wheel speed of the front right wheel 2, the wheel speed of the rear left wheel 3, and the wheel speed of the rear right wheel 3), respectively.

Next, the electric parking brake will be described.

The parking brake switch (PKB-SW) 24 as a switch of the electric parking brake is provided in the vehicle body 1 at a position located close to a driver's seat (not illustrated). The parking brake switch 24 serves as an operation instruction portion operated by the driver. The parking brake switch 24 transmits a signal (an actuation request signal) corresponding to a request to actuate the parking brake (an application request handled as a maintenance request or a release request handled as a clearing request) according to an operation instruction from the driver to the braking control apparatus 17. In other words, the parking brake switch 24 outputs the actuation request signal to actuate the piston 6D and thus the brake pads 6C for the application (the maintenance) or for the release (the clearing) (an application request signal handled as a maintenance request signal or a release request signal handled as a clearing request signal) based on the driving (the rotation) of the electric motor 7A to the braking control apparatus 17.

When the parking brake switch 24 is operated by the driver toward a braking side (an application side), i.e., when the application request (the braking maintenance request) for applying the braking force to the vehicle is issued, the application request signal (the parking brake request signal or the application instruction) is output from the parking brake switch 24. In this case, the electric motor 7A of the rear wheel-side disk brake 6 receives supply of electric power for rotating this electric motor 7A toward a braking side via the braking control apparatus 17. At this time, the rotation-linear motion conversion mechanism 8 thrusts (presses) the piston 6D toward the disk rotor 4 side based on the rotation of the electric motor 7A, and holds the thrust piston 6D. As a result, the rear wheel-side disk brake 6 is brought into a state applying the braking force as the parking brake (or the auxiliary brake), i.e., an application state (a braking maintenance state).

On the other hand, when the parking brake switch 24 is operated by the driver toward a braking release side (a release side), i.e., when the release request for releasing the braking force on the vehicle (the braking release request) is issued, the release request signal (a parking brake release request signal or a release instruction) is output from the parking brake switch 24. In this case, the electric motor 7A of the rear wheel-side disk brake 6 receives supply of electric power for rotating this electric motor 7A in the opposite direction from the braking side via the braking control apparatus 17. At this time, the rotation-linear motion conversion mechanism 8 releases the holding of the piston 6D (releases the pressing force exerted by the piston 6D) based on the rotation of the electric motor 7A. As a result, the rear wheel-side disk brake 6 is brought into a state releasing the application of the braking force as the parking brake (or the auxiliary brake), i.e., a release state (a braking release state).

The parking brake can be configured to be automatically applied (an automatic application) based on an automatic application request according to a logic for determining the application of the parking brake by the braking control apparatus 17, for example, when the vehicle is kept stopped for a predetermined time (the vehicle is determined to be stopped, for example, when being kept in a state that the speed detected by the vehicle speed sensor is lower than 5 km/h for a predetermined time according to a slow-down while the vehicle is running), when the engine is stopped, when the gearshift is operated to P, when the door is opened, or when the safety belt is unlocked. Further, the parking brake can be configured to be automatically released (an automatic release) based on an automatic release request according to a logic for determining the release of the parking brake by the braking control apparatus 17, for example, when the vehicle is running (the vehicle is determined to be running, for example, when being kept in a state that the speed detected by the vehicle speed sensor is 6 km/h or higher for a predetermined time according to a speed-up from the stopped state), when the accelerator pedal is operated, when the clutch pedal is operated, or when the gearshift is operated to a position other than P and N. The automatic application and the automatic release can be configured as an auxiliary function usable at the time of a failure in the switch, which automatically applies or releases the braking force when a failure has occurred in the parking brake switch 24.

Further, the electric parking brake can be configured to be able to apply and release the braking force by the ESC 16 according to, for example, the operation performed on the parking brake switch 24 when the parking brake switch 24 is operated while the vehicle is running, more specifically, when a dynamic parking brake (a dynamic application), such as using the parking brake as the auxiliary brake urgently while the vehicle is running, is requested. In this case, the braking control apparatus 17 controls the ESC 16 according to the operation performed on the parking brake switch 24. For example, the braking control apparatus 17 applies the braking force with use of the hydraulic pressure while the parking brake switch 24 is operated to the braking side (while the operation toward the braking side continues), and releases the application of the braking force using the hydraulic pressure when this operation is ended.

On the other hand, the electric parking brake can be configured to apply and release the braking force based on, for example, the driving of the electric motor 7A of the rear wheel-side disk brake 6 instead of applying and releasing the braking force based on the ESC 16 when the parking brake switch 24 is operated while the vehicle is running. In this case, for example, the braking control apparatus 17 applies the braking force based on the driving of the electric motor 7A while the parking brake switch 24 is operated to the braking side (while the operation toward the braking side continues), and releases the application of the braking force based on the driving of the electric motor 7A when this operation is ended. The braking control apparatus 17 can be configured to automatically apply and release the braking force according to the state of the wheel (each of the rear wheels 3), i.e., whether the wheel is locked (slipping) or not at this time (the ABS control).

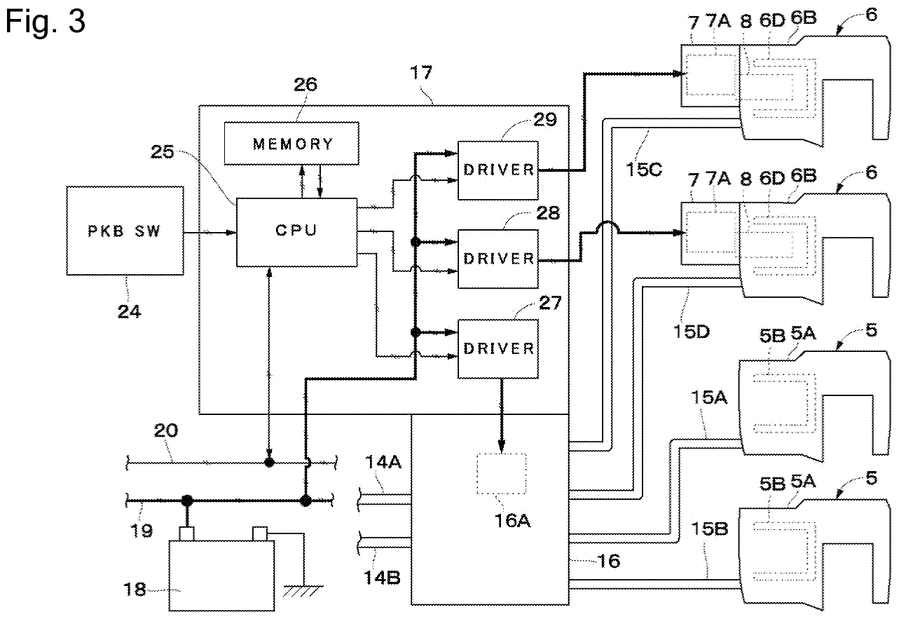

The braking control apparatus 17 as the control apparatus (the electric brake control apparatus) forms the electric brake apparatus together with the rear wheel-side disk brake 6 (the electric motor 7A and the rotation-linear motion conversion mechanism 8 thereof). The braking control apparatus 17 controls the driving of the electric motor 7A. For fulfilling this function, the braking control apparatus 17 includes an arithmetic circuit (CPU) 25 including a microcomputer or the like, and a memory 26, as illustrated in FIG. 3. Electric power from the battery 18 (or the generator driven by the engine) is supplied to the braking control apparatus 17 via the electric power source line 19. For example, the arithmetic circuit 25 can be configured as a dual-core unit (a dual-circuit unit) that performs the same processing in parallel and also mutually monitors whether there is a difference between the processing results. In this case, even when a failure has occurred in one of the cores (the circuits), the control can continue (can be backed up by the other of the cores (the circuits). Further, the braking control apparatus 17 may be configured to include two arithmetic circuits, i.e., an arithmetic circuit for the ESC and an arithmetic circuit for the electric parking brake, although this configuration is omitted in the illustration.

As described above, the braking control apparatus 17 controls the opening/closing of each of the control valves and the driving of the electric motor 16A of the ESC 16, thereby reducing, maintaining, increasing, or pressurizing the brake hydraulic pressure to supply to each of the disk brakes 5 and 6. In addition thereto, the braking control apparatus 17 controls the electric motor 7A of the rear wheel-side disk brake 6 to generate the braking force (the parking brake or the auxiliary brake) when the vehicle is parked or stopped (or is running as necessary). In other words, the braking control apparatus 17 actuates (applies or releases) the disk brake 6 as the parking brake (the auxiliary brake when necessary) by driving each of the left and right electric motors 7A.

For fulfilling this function, the input side of the braking control apparatus 17 is connected to the parking brake switch 24, and the output side thereof is connected to the electric motor 7A of each of the disk brakes 6. Then, the braking control apparatus 17 includes the arithmetic circuit 25, an ESC driving circuit 27, and parking driving circuits 28 and 29 built therein. The arithmetic circuit 25 is used to, for example, control the supply of the hydraulic pressure of the ESC 16, detect the vehicle's start to move, and determine an instruction to drive the electric motor 7A of the electric parking brake. The ESC driving circuit 27 is used to control, for example, the electric motor 16A of the ESC 16. The parking driving circuits 28 and 29 are used to control the electric motor 7A of the electric parking brake. In this case, the ESC driving circuit 27 is a circuit for controlling the supply of the hydraulic pressure, and detecting a failure.

The braking control apparatus 17 drives the left and right electric motors 7A to apply (maintain) or release (clear) the braking forces on the left and right disk brakes 6 based on the actuation request (the application request or the release request) according to the operation performed on the parking brake switch 24 by the driver, the actuation request according to the logic for determining the application or release of the parking brake, or the actuation request according to the ABS control. At this time, the rear wheel-side disk brake 6 holds or releases the piston 6D and the brake pads 6C by the rotation-linear motion conversion mechanism 8 based on the driving of each of the electric motors 7A. In this manner, the braking control apparatus 17 controls the driving of the electric motor 7A so as to thrust the piston 6D (and thus the brake pads 6C) according to the actuation request signal to actuate the piston 6D (and thus the brake pads 6C) for the maintenance (the application) or for the release (the clearing).

As illustrated in FIG. 3, the parking brake switch 24, the vehicle data bus 20, the driving circuits 27, 28, and 29, and the like, in addition to the memory 26 as a storage portion, are connected to the arithmetic circuit 25 of the braking control apparatus 17. Various kinds of state amounts of the vehicle that are required to control the ESC 16 and control (actuate) the electric parking brake, i.e., various kinds of vehicle information can be acquired from the vehicle data bus 20. For example, the braking control apparatus 17 can acquire the detection signals (the wheel speed pulses) of the wheel speed sensors 23 via the vehicle data bus 20.

The braking control apparatus 17 may be configured in such a manner that the sensor that detects this information is directly connected to the braking control apparatus 17 (the arithmetic circuit 25 thereof), and the vehicle information fed from the vehicle data bus 20 is acquired thereby. For example, the wheel speed sensors 23 may be directly connected to the braking control apparatus 17. The W/C pressure sensor 21 and the M/C pressure sensor 22 may be directly connected to the braking control apparatus 17. Further, the arithmetic circuit 25 of the braking control apparatus 17 may be configured in such a manner that the actuation request based on the above-described determination logic or the ABS control is input from another control apparatus (ESC) connected to the vehicle data bus 20. In this case, the electric parking brake can be configured in such a manner that the other control apparatus determines whether to apply/release the parking brake according to the above-described determination logic and controls the ABS, instead of the braking control apparatus 17.

The braking control apparatus 17 includes the memory 26 as the storage portion embodied by, for example, a flash memory, a ROM, a RAM, or an EEPROM. A control program of the ESC 16 and a control program of the electric parking brake (the electric motor 7A) are stored in the memory 26. In this case, a processing program for performing a processing flow illustrated in FIG. 4, which will be described below, i.e., a processing program used to control a reapplication (re-clamping) based on detection of the vehicle's start to move after the completion of the application is stored in the memory 26.

Further, the braking control apparatus 17 stores the current state (status) of the parking brake that is established using the electric motor 7A into the memory 26. More specifically, the braking state indicating that the electric parking brake maintains or releases the braking (the maintenance state, the release state, an unknown state when necessary, or the like) is stored into the memory 26. In this case, the state of the electric parking brake (i.e., a state about the maintenance of the thrust force applied to the piston 6D by the rotation-linear motion conversion mechanism 8) is updatably stored into the memory 26 each time this state is changed. For example, the arithmetic circuit 25 of the braking control apparatus 17 determines whether the state of the rear wheel-side disk brake 6 (the piston 6D thereof) is any of the maintenance state (application completed), the release state (release completed), and the unknown state (or a driving ongoing state), and the result of this determination is stored into the memory 26 when necessary or a timing at which one actuation processing procedure is ended. Due to this storage, the arithmetic circuit 25 of the braking control apparatus 17 can determine the braking state (the open/close state) of the electric parking brake.

As illustrated in FIG. 3, the braking control apparatus 17 includes the ESC driving circuit 27, the one-side parking driving circuit 28, and the other-side parking driving circuit 29 built therein. The ESC driving circuit 27 drives the electric motor 16A and each of the control valves (the solenoid thereof) of the ESC 16. The one-side parking driving circuit 28 drives the electric motor 7A of the rear wheel-side disk brake 6 on one side (for example, the left side). The other-side parking driving circuit 29 drives the electric motor 7A of the rear wheel-side disk brake 6 on the other side (for example, the right side). Further, the braking control apparatus 17 includes a voltage sensor, a current sensor, and the like built therein, although this configuration is omitted in the illustration. The voltage sensor detects a voltage from the electric power source line 19. The current sensor detects a motor current of each of the electric motors 7A and 16A. The ESC driving circuit 27, the one-side parking driving circuit 28, the other-side parking driving circuit 29, the voltage sensor, and the current sensor are each connected to the arithmetic circuit 25.

Due to this configuration, the arithmetic circuit 25 of the braking control apparatus 17 can determine whether the supply of the hydraulic pressure to the disk brakes 5 and 6 is normal or not based on, for example, the current value of the electric motor 16A of the ESC 16 that is detected by the current sensor, and further, the presence or absence of the brake operation that is detected by the above-described brake operation detection sensor 10, and the hydraulic pressure value(s) detected by the W/C pressure sensor 21 and/or the M/C pressure sensor 22. Further, the arithmetic circuit 25 of the braking control apparatus 17 can, for example, determine whether the disk rotor 4 and the brake pads 6C are in abutment with or separated from each other, and determine whether to stop the driving of the electric motor 7A (determine the completion of the application or determine the completion of the release) based on the current value (a change therein) of the electric motor 7A that is detected by the current sensor when applying or releasing the brake.

Now, when detecting a vibration accompanying the vehicle's unexpected start to move while applying the electric parking brake, the above-described conventional technique increases the thrust force until this vibration disappears. In this case, the conventional technique determines (detects) the vehicle's start to move based on the vibration of the wheel cylinder. Therefore, the conventional technique may erroneously determine that the vehicle has started to move and increase the thrust force (the braking force) despite the fact that the vehicle can be actually kept in the parked state. For example, the conventional technique may make the erroneous determination by mistaking a vibration accompanying the user's (passenger's) getting into/out of the vehicle, loading/unloading the baggage, or the like as the vibration accompanying the vehicle's start to move. Alternatively, the conventional technique may erroneously determine that the vehicle has started to move by mistaking inertial running before the vehicle is stopped as the vehicle's start to move, when the electric parking brake is used as the emergency brake while the vehicle is running. As a result, the conventional technique may end up excessively applying the braking force, and cause an increase in time taken to complete the release of the brake when releasing the electric brake next time (releasing the braking force) (a reduction in the responsiveness).

Under these circumstances, the embodiment determines that the vehicle has started to move when the wheel speed pulses are generated instead of determining the vehicle's unexpected start to move based on the vibration generated on the wheel cylinder. As one example of the vehicle's unexpected start to move, for example, the vehicle may slip back. Further, in the embodiment, the braking control apparatus 17 distinguishes the information about the wheel speed pulse among the four front left, front right, rear left, and rear right wheels (the wheels 2 and 3), and monitors whether or not the wheel speed pulses are generated on at least one wheel for each of the front wheels 2 and the rear wheels 3. Further, the braking control apparatus 17 monitors the vehicle's start to move after the vehicle is brought into the stopped state, more specifically, after a predetermined time (a predetermined determination mask time) has passed since the start to maintain the braking force, instead of monitoring the vehicle's start to move immediately after the actuation of the electric parking brake. In other words, the arithmetic circuit 25 of the braking control apparatus 17 determines (detects) whether the vehicle has started to move or not based on the wheel speed pulses acquired from the vehicle data bus 20. Then, the braking control apparatus 17 attempts a reapplication (re-clamping), i.e., drives the electric motor 7A again if determining that the vehicle has started to move despite the fact that the electric parking brake is in the application state.

More specifically, the braking control apparatus 17 drives the electric motor 7A to apply (increase) the braking force when the respective wheel speed sensors 23 detect the wheel speed pulses (the wheel speeds) from at least two wheels 2 and 3 after the braking force starts to be maintained (after the application is completed). At this time, the braking control apparatus 17 acquires the wheel speed information from the plurality of wheels 2 and 3 (i.e., the information about the wheel speed pulses output by the wheel speed sensors 23). Along therewith, the braking control apparatus 17 controls the driving of the electric motor 7A, which drives the electric mechanism that applies the braking force to the vehicle and maintains this braking force. Then, the braking control apparatus 17 drives the electric motor 7A to apply the braking force when acquiring the wheel speed information (wheel speed detection information or wheel speed pulse detection information) regarding at least two wheels 2 and 3 after starting to maintain the braking force. In other words, the braking control apparatus 17 drives the electric motor 7A again to increase the braking force when the wheel speed sensors 23 of at least two wheels 2 and 3 detect the wheel speed pulses after the braking control apparatus 17 drives the electric motor 7A and starts to maintain the braking force.

In this case, the braking control apparatus 17 drives the electric motor 7A to apply the braking force when the wheel speed sensors 23 detect the wheel speed pulses from at least one wheel for each of the front wheels 2 and the rear wheels 3. In other words, the braking control apparatus 17 drives the electric motor 7A to apply the braking force when detecting the wheel speed pulses from at least one of the rear left wheel 3 and the rear right wheel 3 and at least one of the front left wheel 2 and the front right wheel 2. The braking control apparatus 17 may be configured to drive the electric motor 7A to apply the braking force when detecting the wheel speed pulses from both the front left and right wheels 2. Alternatively, the braking control apparatus 17 may be configured to drive the electric motor 7A to apply the braking force when detecting the wheel speed pulses from both the rear left and right wheels 3. The braking control apparatus 17 may drive the electric motors 7A on both the left side and the right side of the vehicle, or may drive only the electric motor 7A on the detected side where the wheel speed pulse is detected (the left side or the right side) when detecting the wheel speed pulse on only the left side or only the right side of the vehicle.

Further, the braking control apparatus 17 drives the electric motor 7A to apply the braking force when the wheel speed sensors 23 detect the wheel speed pulses from at least two or more wheels 2 and 3 after the braking control apparatus 17 determines that the vehicle is in the stopped state. In this case, the braking control apparatus 17 determines that the vehicle is in the stopped state when the predetermined time (the predetermined determination mask time) has passed after the start to maintain the braking force. For example, the braking control apparatus 17 determines that the vehicle is in the stopped state when 500 ms have passed since the completion of the application on the both wheels or when 500 ms have passed since a change of the vehicle body speed (the vehicle speed) to 0 Km/h. Alternatively, the braking control apparatus 17 may determine that the vehicle is in the stopped state when a change in the acceleration sensor mounted on the vehicle is converged or the vehicle speed falls below a predetermined value after the start to maintain the braking force. Alternatively, the braking control apparatus 17 may determine that the vehicle is in the stopped state, for example, when the position (the selected position) of the gearshift of a transmission (a running switching apparatus) is placed at the parking position (the P position).

Further, each of the wheel speed sensors 23 may detect the number of wheel speed pulses during a predetermined period. More specifically, the braking control apparatus 17 may determine (detect) the vehicle's start to move based on the number of wheel speed pulses output from the wheel speed sensor 23 per predetermined period (for example, a cycle of 10 ms), and drive the electric motor 7A. Such control of the driving (the reapplication) of the electric motor 7A by the braking control apparatus 17, i.e., the control processing illustrated in FIG. 4 will be described in detail below.

The brake system of the four-wheeled automobile according to the first embodiment is configured in the above-described manner, and an operation thereof will be described next.

When the driver of the vehicle operates the brake pedal 9 by pressing it, this pressing force is transmitted to the master cylinder 12 via the booster 11, and the brake hydraulic pressure is generated by the master cylinder 12. The brake hydraulic pressure generated in the master cylinder 12 is distributed and supplied to each of the disk brakes 5 and 6 via the cylinder-side hydraulic pressure pipes 14A and 14B, the ESC 16, and the brake-side pipe portions 15A, 15B, 15C, and 15D, and the braking force is applied to each of the front left and right wheels 2 and the rear left and right wheels 3.

In this case, in each of the disk brakes 5 and 6, the piston 5B or 6D is slidably displaced toward the brake pads 6C according to an increase in the brake hydraulic pressure in the caliper 5A or 6B, and the brake pads 6C are pressed against the disk rotor 4 or 4. As a result, the braking force based on the hydraulic pressure is generated. On the other hand, when the brake operation is released, the supply of the hydraulic pressure into the caliper 5A or 6B is stopped, which causes the piston 5B or 6D to be displaced so as to be separated (retracted) from the disk rotor 4 or 4. As a result, the brake pads 6C are separated from the disk rotor 4 or 4, whereby the vehicle is returned into a non-braked state.

Next, when the driver of the vehicle operates the parking brake switch 24 toward the braking side (the application side), electric power is supplied from the braking control apparatus 17 to the electric motor 7A of the rear wheel-side disk brake 6 on each of the left side and the right side, and the electric motor 7A is rotationally driven. In the rear wheel-side disk brake 6, the rotational motion of the electric motor 7A is converted into the linear motion by the rotation-linear motion conversion mechanism 8, and the piston 6D is thrust by the rotation-linear motion member 8A. As a result, the brake pads 6C are pressed against the disk rotor 4. At this time, the rotation-linear motion conversion mechanism 8 (the liner motion member 8A2) is kept in the braking state by, for example, the frictional force (the holding force) due to the threaded engagement. As a result, the rear wheel-side disk brake 6 is actuated (applied) as the parking brake. In other words, even after the supply of electric power to the electric motor 7A is stopped, the piston 6D is held at the braking position by the rotation-linear motion conversion mechanism 8.

On the other hand, when the driver operates the parking brake switch 24 toward the braking release side (the release side), electric power is supplied from the braking control apparatus 17 to the electric motor 7A so as to rotate the motor in the reverse direction. This supply of electric power causes the electric motor 7A to be rotated in the opposite direction from the direction at the time of the actuation (the application) of the parking brake. At this time, the braking force maintained by the rotation-linear motion conversion mechanism 8 is released, which allows the piston 6D to be displaced in a direction away from the disk rotor 4. As a result, the actuation of the rear wheel-side disk brake 6 as the parking brake is released (cleared).

Next, the control processing performed by the arithmetic circuit 25 of the braking control apparatus 17 will be described with reference to FIG. 4. The control processing illustrated in FIG. 4 is repeatedly performed per predetermined control cycle (for example, 10 ms) while electric power is kept supplied to the braking control apparatus 17.

When the braking control apparatus 17, which is the ECU (the Electronic Control Unit), is actuated, the control processing illustrated in FIG. 4 is started. In S1, the braking control apparatus 17 determines whether the vehicle is currently stopped or not. The braking control apparatus 17 can determine whether the vehicle is currently stopped or not based on whether the vehicle speed calculated from the wheel speeds detected by the wheel speed sensors 23 is equal to or lower than a predetermined value or not (for example, 1 Km/h). A vehicle speed received from an external system via the vehicle data bus 20 or the like, or a state amount related to the vehicle speed may be used as the vehicle speed.

If the braking control apparatus 17 determines “YES”, i.e., determines that the vehicle is currently stopped in Si, the processing proceeds to S2. On the other hand, if the braking control apparatus 17 determines “NO”, i.e., determines that the vehicle is not currently stopped (the vehicle is running) in S1, the processing proceeds to S5. In S2, the braking control apparatus 17 determines whether or not the electric parking brakes of the rear wheel-side disk brakes 6 on the left side and the right side are in the application states (currently maintain the braking). In other words, in S2, the braking control apparatus 17 determines whether or not the electric parking brakes on both the left and right wheels (the rear wheels 3 on the left side and the right side) are in the application completed states. The braking control apparatus 17 can determine whether or not the electric parking brakes are in the application states (currently maintain the braking) based on the current states (statuses) of the parking brakes stored in the memory 26 of the braking control apparatus 17. In other words, the states of the parking brakes on the both wheels are constantly determined by the arithmetic circuit 25.

If the braking control apparatus 17 determines “YES”, i.e., determines that the electric parking brakes on both the left and right wheels are in the application completed states in S2, the processing proceeds to S3. On the other hand, if the braking control apparatus 17 determines “NO”, i.e., determines that the electric parking brakes on both the left and right wheels are not in the application completed states (for example, the electric parking brakes are in the release states) in S2, the processing proceeds to S5. In S3, the braking control apparatus 17 determines whether or not the re-clamping (the reapplication) based on the detection of the vehicle's start to move has been unperformed after a transition of the parking brake from the release state to the application state. In other words, in S3, the braking control apparatus 17 determines whether the re-clamping in S10, which will be described below, has been unperformed or has been performed already.

If the braking control apparatus 17 determines “YES”, i.e., determines that the re-clamping based on the detection of the vehicle's start to move has been unperformed in S3, the processing proceeds to S4. On the other hand, if the braking control apparatus 17 determines “NO”, i.e., determines that the re-clamping based on the detection of the vehicle's start to move has not been unperformed (has been performed) in S3, the processing proceeds to S5. By this determination, the braking control apparatus 17 prevents the re-clamping from being further repeated when the re-clamping has been performed already. Therefore, the braking control apparatus 17 can prevent the re-clamping (the reapplication) from being excessively performed. The braking control apparatus 17 may be configured to allow the re-clamping to be performed twice or more according to the strength of the rear wheel-side disk brake 6, an adopted criterion, or the like. In other words, the number of times that the re-clamping is performed can be limited to within a preset predetermined number of times.

In S4, the braking control apparatus 17 counts the mask time elapsed since the transition of the electric parking brake to the application state and the transition of the vehicle to the stopped state. On the other hand, if the condition of step S51 or S3 is not satisfied (if the determination therein is “NO”), in S5, the braking control apparatus 17 clears the mask time (set it to 0 ms). Then, the processing proceeds to RETURN. In other words, the processing returns to START via RETURN, and Si and the steps subsequent thereto are repeated.

In S6 subsequent to S4, the braking control apparatus 17 determines whether or not the mask time elapsed since the transition of the electric parking brake to the application state and the transition of the vehicle to the stopped state exceeds a predetermined time (for example, 500 ms). If the braking control apparatus 17 determines “YES”, i.e., determines that the mask time counted in S4 exceeds the predetermined time (for example, 500 ms) in S6, the processing proceeds to S7. On the other hand, if the braking control apparatus 17 determines “NO”, i.e., determines that the mask time does not exceed the predetermined time (for example, 500 ms) in S6, the processing proceeds to RETURN.

In S7, the braking control apparatus 17 determines whether or not the wheel speed pulse is generated on any of the rear left wheel 3 and the rear right wheel 3. In other words, in S7, the braking control apparatus 17 determines whether or not the wheel speed pulses are detected by the wheel speed sensors 23 respectively mounted in correspondence with the rear left wheel 3 and the rear right wheel 3. If the braking control apparatus 17 determines “YES”, i.e., determines that the wheel speed pulse is detected on any of the rear left wheel 3 and rear right wheel 3 in S7, the processing proceeds to S8. On the other hand, if the braking control apparatus 17 determines “NO”, i.e., determines that the wheel speed pulse is detected on neither the rear left wheel 3 nor the rear right wheel 3 in S7, the processing proceeds to RETURN. The braking control apparatus 17 can be prevented from erroneously determining the vehicle's start to move by confirming whether or not the wheel speed pulse is generated on the rear wheel 3 side first in S7 in this manner. More specifically, when the front wheels 2 not subjected to the application of the braking force are rotated (for example, when the front wheels 2 are rotated according to a startup of the engine, the user's (passenger's) getting into/out of the vehicle, loading/unloading the baggage, or the like), the braking control apparatus 17 can be prevented from erroneously determining the vehicle's start to move by mistaking these rotations as the vehicle's start to move. Further, the braking control apparatus 17 can detect (determine) the vehicle's start to move further early by monitoring whether the wheel speed pulse is generated instead of counting the number of wheel speed pulses in S7 (and S8, which will be described below).

In S8, the braking control apparatus 17 determines whether or not the wheel speed pulse is generated on any of the front left wheel 2 and the front right wheel 2. In other words, in S8, the braking control apparatus 17 determines whether or not the wheel speed pulses are detected by the wheel speed sensors 23 respectively mounted in correspondence with the front left wheel 2 and the front right wheel 2. If the braking control apparatus 17 determines “YES”, i.e., determines that the wheel speed pulse is detected on any of the front left wheel 2 and front right wheel 2 in S8, the processing proceeds to S9. On the other hand, if the braking control apparatus 17 determines “NO”, i.e., determines that the wheel speed pulse is detected on neither the front left wheel 2 nor the front right wheel 2 in S8, the processing proceeds to RETURN. In this manner, according to the embodiment, the braking control apparatus 17 can improve tolerance against noise by not only monitoring the rear wheels 3 in S7 but also monitoring the front wheels 2 in S8.

In S9, the braking control apparatus 17 confirms that the driving request is absent. More specifically, in S9, the braking control apparatus 17 determines that “the driving request is absent (YES)” or “the driving request is present (NO)”. More specifically, in S9, the braking control apparatus 17 detects whether or not the release request is issued based on the operation performed on the parking brake switch 24, and whether or not the accelerator is operated by the driver (the automatic release request is issued based thereon). If the braking control apparatus 17 determines “YES”, i.e., determines that the driving request is absent (the release request is absent and the accelerator operation is absent) in S9, the processing proceeds to S10. On the other hand, if the braking control apparatus 17 determines “NO”, i.e., determines that the driving request is present (the release request is present or the accelerator operation is present) in S9, the processing proceeds to RETURN. The braking control apparatus 17 can control the brake as intended by the driver by canceling the re-clamping based on the detection of the vehicle's start to move and prioritizing the driving request when the driving request is issued in this manner.

In S10, the braking control apparatus 17 performs the re-clamping based on the detection of the vehicle's start to move. More specifically, the braking control apparatus 17 further drives the electric motor 7A to the application side to apply (increase) the braking force. In this case, the braking control apparatus 17 may drive both the electric motor 7A on the left side that is provided in correspondence with the rear left wheel 3 and the electric motor 7A on the right side that is provided in correspondence with the rear right wheel 3. Alternatively, for example, when the wheel speed pulse is detected on only the left side or only the right side of the vehicle, the braking control apparatus 17 may drive only the electric motor 7A on the detected side where the wheel speed pulse is detected (the left side or the right side). After the braking control apparatus 17 drives the electric motor 7A in S10, the processing proceeds to RETURN.

In this manner, according to the embodiment, the braking control apparatus 17 detects the vehicle's unexpected start to move based on the wheel speed information instead of detecting the vehicle's unexpected start to move (for example, the vehicle slips back) based on the vibration generated on the wheel cylinder. In other words, the braking control apparatus 17 detects the vehicle's start to move based on whether or not the wheel speed pulses are generated from the wheel speed sensors 23. As a result, the braking control apparatus 17 can detect the state in which the wheels 2 and 3 rotate, thereby preventing the erroneous detection of the vehicle's start to move. For example, even when the wheel cylinder vibrates along with the user's (the passenger's) getting into/out of the vehicle, loading/unloading the baggage, or the like, the electric motor 7A is not driven unless the wheels 2 and 3 rotate and the wheel speed pulses are detected. As a result, the present embodiment can allow the vehicle's start to move to be detected with improved accuracy. In addition, the braking control apparatus 17 drives the electric motor 7A when detecting the wheel speed pulses from two wheels 2 and 3 among the plurality of wheels 2 and 3. In other words, the braking control apparatus 17 monitors the wheel speed pulses of the four front left, front right, rear left, and rear right wheels 2 and 3, and also drives the electric motor 7A when detecting the wheel speed pulses from two wheels 2 and 3 among them. Therefore, the present embodiment can enhance the tolerance against noise, and can also allow the vehicle's start to move to be detected with improved accuracy from this aspect. As a result, the present embodiment can allow the vehicle's unexpected start to move to be accurately detected and allow a required braking force to be applied.

According to the embodiment, the braking control apparatus 17 detects the vehicle's unexpected start to move based on the wheel speed pulses generated from at least one wheel of each of the front wheels 2 and the rear wheels 3 (=one of the front left and right wheels 2 and one of the rear left and right wheels 3) instead of detecting the vehicle's unexpected start to move based on the wheel speed pulse generated on only the front wheel 2 or only the rear wheel 3. In other words, the braking control apparatus 17 can recognize that the rear wheel 3 rotates by distinguishing the wheel speed pulse generated on each of the wheels 2 and 3 between the front and rear sides, instead of using the wheel speed pulses of the four front left, front right, rear left, and rear right wheels 2 and 3 without distinguishing them for the detection of the vehicle's start to move. Therefore, the present embodiment can prevent the electric motor 7A from being further driven (prevent the thrust force from unintentionally increasing), for example, under a situation that the rear wheel 3 is accidentally locked on a low μ road.

According to the embodiment, the braking control apparatus 17 monitors the vehicle's unexpected start to move after the vehicle is brought into the stopped state instead of monitoring the vehicle's unexpected start to move since immediately after the start to maintain the braking force. Therefore, for example, when the braking force starts to be maintained while the vehicle is running, the vehicle's start to move can be detected after the vehicle is stopped. Therefore, for example, when the electric parking brake is used as the emergency brake while the vehicle is running, the present embodiment can prevent the braking control apparatus 17 from erroneously determining the vehicle's start to move by mistaking the inertial running before the vehicle is stopped as the vehicle's start to move. Further, the present embodiment can prevent the braking control apparatus 17 from erroneously detecting the vehicle's start to move when the vehicle swings back upon being stopped, by mistaking such a motion as the vehicle's start to move. Therefore, the present embodiment can also allow the vehicle's unexpected start to move to be detected with improved accuracy from this aspect.

According to the embodiment, the braking control apparatus 17 monitors the vehicle's unexpected start to move after the predetermined time (the predetermined determination mask time) has passed instead of monitoring the vehicle's unexpected start to move since immediately after the start to maintain the braking force. Therefore, the present embodiment can prevent the braking control apparatus 17 from erroneously detecting the vehicle's start to move when the vehicle inertially runs before being stopped or when the vehicle swings back upon being stopped, by mistaking such a motion as the vehicle's start to move.

According to the embodiment, each of the wheel speed sensors 23 as the wheel speed detection portion detects the wheel speed pulse as the wheel speed. In this case, the wheel speed sensor 23 detects whether the wheel speed pulse is generated or the number of wheel speed pulses during the predetermined period (for example, the number of wheel speed pulses per 10 ms). As a result, the present embodiment can allow the wheel speed pulse (i.e., the generation of the wheel speed pulse, the wheel speed, and thus the vehicle's start to move) to be accurately detected.

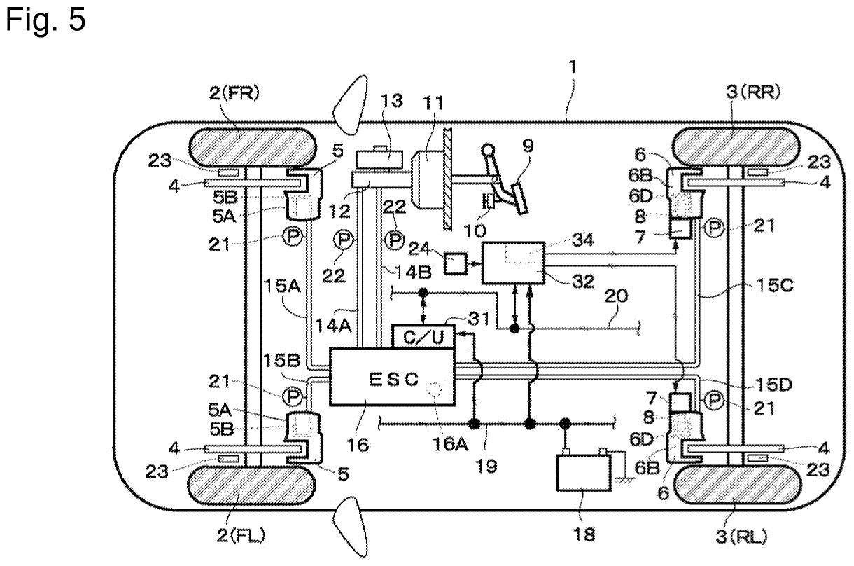

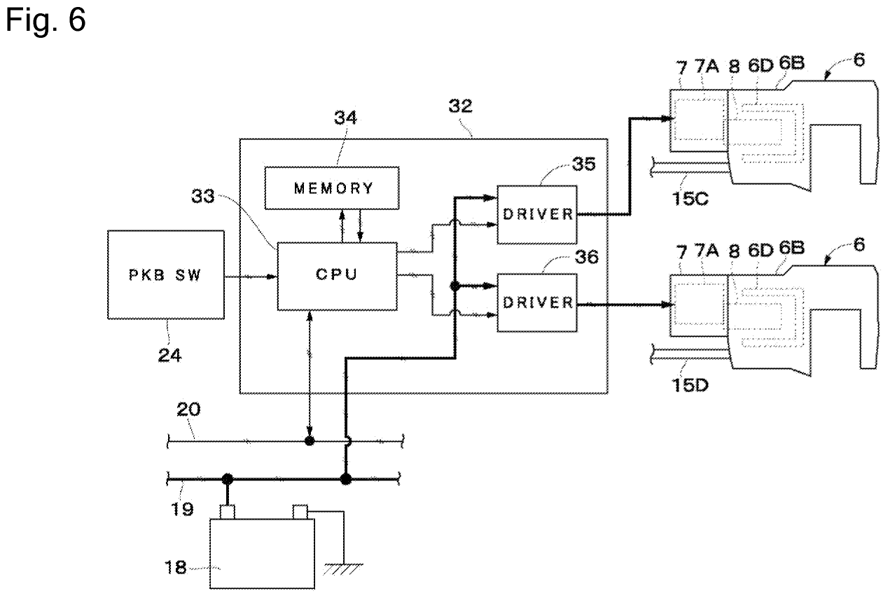

Next, FIGS. 5 and 6 illustrate a second embodiment. The second embodiment is characterized in that different control apparatuses are individually provided as the control apparatus that controls the hydraulic pressure supply apparatus and the control apparatus that controls the electric brake apparatus, respectively. The second embodiment will be described, indicating similar constituent components to the first embodiment by the same reference numerals and omitting descriptions thereof.

In FIG. 5, an ESC control apparatus 31 is an ESC control unit that controls the ESC 16 (an ECU for the ESC). The ESC control apparatus 31 includes a microcomputer, and controls the driving of each of the control valves (the solenoid thereof) of the ESC 16 and the electric motor 16A for the hydraulic pressure pump, similarly to the braking control apparatus 17 according to the first embodiment. The ESC control apparatus 31 is different from the braking control apparatus 17 according to the first embodiment in terms of not controlling the electric motor 7A of the rear wheel-side disk brake 6.

For example, the brake operation detection sensor 10, the W/C pressure sensor 21, the M/C pressure sensor 22, the wheel speed sensors 23, and the vehicle data bus 20 are connected to the ESC control apparatus 31. The ESC control apparatus 31 outputs the information (the detection results) detected by the brake operation detection sensor 10, the W/C pressure sensor 21, the M/C pressure sensor 22, and the wheel speed sensors 23 to the vehicle data bus 20.

On the other hand, a parking brake control apparatus 32 as the control apparatus (the electric brake control apparatus) is a control unit for the parking brake (an ECU for the parking brake) that controls the rear wheel-side disk brake 6 (the electric motor 7A thereof). The parking brake control apparatus 32 includes a microcomputer, and controls the driving of the electric motor 7A of the rear wheel-side disk brake 6, similarly to the braking control apparatus 17 according to the first embodiment. The parking brake control apparatus 32 is different from the braking control apparatus 17 according to the first embodiment in terms of not controlling the ESC 16.

The parking brake control apparatus 32 is connected to various kinds of control apparatuses (ECUs: Electronic Control Units) including the ESC control apparatus 31 via the vehicle data bus 20. The parking brake control apparatus 32 can acquire various kinds of state amounts of the vehicle that are required to control (actuate) the parking brake, i.e., various kinds of vehicle information from the vehicle data bus 20. Further, the parking brake switch 24 is connected to the parking brake control apparatus 32.

The parking brake control apparatus 32 generates the braking force (the parking brake or the auxiliary brake) when the vehicle is parked or stopped (or is running as necessary) by controlling the electric motor 7A of the rear wheel-side disk brake 6. Further, the parking brake control apparatus 32 is configured to control the two rear wheel-side disk brakes 6 on the left side and the right side, but may be provided for each of the rear wheel-sidedisk brakes 6 on the left side and the right side. In this case, the parking brake control apparatus 32 can be mounted even integrally with the rear wheel-side disk brake 6.

As illustrated in FIG. 6, the parking brake control apparatus 32 includes an arithmetic circuit 33, a memory 34 as the storage portion, and driving circuits 35 and 36, which drive the electric motors 7A of the rear wheel-side disk brakes 6 on the left side and the right side, respectively. A control program of the electric parking brake (the electric motor 7A) is stored in the memory 34. In addition thereto, the processing program for performing the above-described processing flow illustrated in FIG. 4, i.e., the processing program used to control the reapplication (the re-clamping) based on the detection of the vehicle's start to move after the completion of the application is stored in the memory 34.

The parking braking control apparatus 32 acquires the wheel speed information from the plurality of wheels 2 and 3 (i.e., the wheel speed pulses output by the wheel speed sensors 23) via the vehicle data bus 20, similarly to the braking control apparatus 17 according to the first embodiment. In this case, the parking brake control apparatus 32 acquires the wheel information from the wheel speed sensors 23 via the ESC control apparatus 31 and the vehicle data bus 20. Along therewith, the parking braking control apparatus 32 applies the braking force to the vehicle, and controls the driving of the electric motor 7A, which drives the electric mechanism that maintains this braking force. Then, the parking braking control apparatus 32 drives the electric motor 7A to apply the braking force when acquiring the wheel speed information (the wheel speed pulses) regarding at least two wheels 2 and 3 after starting to maintain the braking force. More specifically, the parking braking control apparatus 32 drives the electric motor 7A to apply (increase) the braking force when the respective wheel speed sensors 23 detect the wheel speed pulses from at least two wheels 2 and 3 after the start to maintain the braking force.

The second embodiment is configured to control the ESC 16 by the ESC control apparatus 31 and control the rear wheel-side disk brake 6 (the electric motor 7A thereof) by the parking brake control apparatus 32 in the above-described manner, and the basic advantageous effects thereof are not especially different from those achieved by the first embodiment. More specifically, the second embodiment can also allow the vehicle's unexpected start to move to be accurately detected (determined) and allow the required re-clamping (the reapplication) to be performed, similarly to the first embodiment.

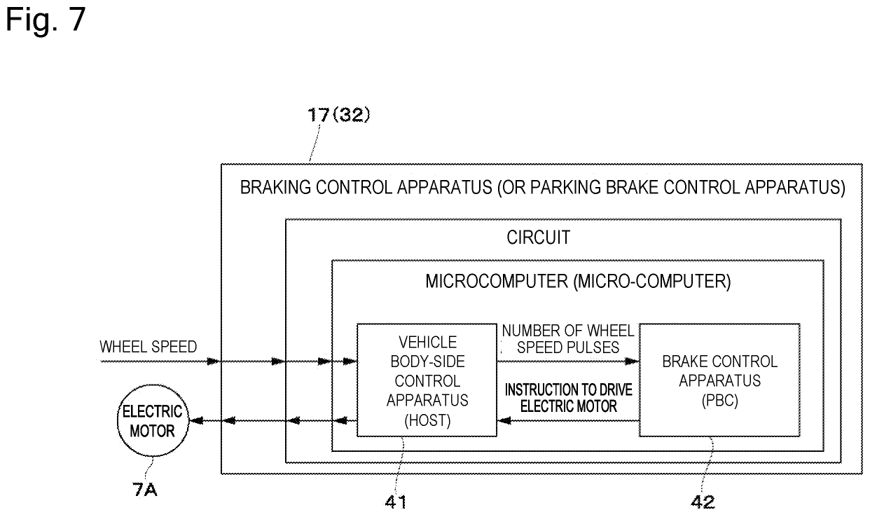

Next, FIG. 7 illustrates a third embodiment. The third embodiment is characterized by including a brake control apparatus that transmits an instruction for driving the electric mechanism and a vehicle body-side control apparatus that receives the instruction from this brake control apparatus. The third embodiment will be described, indicating similar constituent components to the first embodiment by the same reference numerals and omitting descriptions thereof.

The braking control apparatus 17 (or the parking brake control apparatus 32) as the control apparatus (the electric brake control apparatus) that controls the driving of the electric motor 7A includes a vehicle body-side control apparatus 41 corresponding to a HOST (a host apparatus) and a brake control apparatus 42 corresponding to a PBC (a parking brake controller). The vehicle body-side control apparatus 41 receives the wheel speed (the wheel speed pulse) directly from each of the wheel speed sensors 23 or via the vehicle data bus 20, and also transmits this received wheel speed (wheel speed pulse) to the brake control apparatus 42 as the number of wheel speed pulses (for example, the number of pulses per cycle of 10 ms). Further, the vehicle body-side control apparatus 41 drives the electric motor 7A as the electrically-driven motor based on an instruction from the brake control apparatus 42 (an electric motor driving instruction).

For fulfilling this function, the vehicle body-side control apparatus 41 is connected to the wheel speed sensors 23 provided in correspondence with the front left wheel 2, the front right wheel 2, the rear left wheel 3, and the rear right wheel 3 (refer to FIGS. 1 and 5), respectively, directly or via the vehicle data bus 20. The vehicle body-side control apparatus 41 receives the wheel speed information from the plurality of wheels 2 and 3, i.e., the wheel speeds of the four front left, front right, rear left, and rear right wheels 2 and 3 in total from the wheel speed sensors 23 directly or via the vehicle data bus 20. The vehicle body-side control apparatus 41 transmits the received wheel speed information (the wheel speed) to the brake control apparatus 42 as the number of wheel speed pulses of each of the wheels 2 and 3.

The brake control apparatus 42 receives the wheel speed information (the number of wheel speed pulses) acquired from the plurality of wheels 2 and 3 from the wheel body-side control apparatus 41. Further, the brake control apparatus 42 transmits the instruction to drive the electric mechanism that applies the braking force to the vehicle and maintains this braking force (the electric motor driving instruction) to the vehicle body-side control apparatus 41. In other words, the brake control apparatus 42 transmits the electric motor driving instruction to drive the electric mechanism (the electric motor 7A) of the electric parking brake to the vehicle body-side control apparatus 41. Further, the brake control apparatus 42 transmits information indicating that the electric mechanism transitions to the braking force maintenance state to the vehicle body-side control apparatus 41. In this case, the brake control apparatus 42 transmits the instruction to drive the electric motor 7A (the electric motor driving instruction) so as to apply (increase) the braking force to the vehicle body-side control apparatus 41 when receiving the information resulting from detecting the wheel speeds regarding the plurality of wheels 2 and 3 (the number of wheel speed pulses) from the vehicle body-side control apparatus 41 after transmitting the information indicating that the electric mechanism transitions to the braking force maintenance state (the application state) to the vehicle body-side control apparatus 41.

In other words, the brake control apparatus 42 performs the above-described processing flow illustrated in FIG. 4. In this case, the brake control apparatus 42 transmits the information indicating that the electric mechanism transitions to the braking force maintenance state to the vehicle body-side control apparatus 41 if determining that the electric parking brakes on both the left and right wheels (the rear left and right wheels 3) are in the application completed states in S2 illustrated in FIG. 4. After that, the brake control apparatus 42 transmits the instruction to drive the electric motor 7A so as to apply the braking force (the electric motor driving instruction) to the vehicle body-side control apparatus 41 in S10 if receiving the information resulting from detecting the wheel speeds regarding the plurality of wheels 2 and 3 (the number of wheel speed pulses) from the vehicle body-side control apparatus 41 in S7 and S8.

The third embodiment is configured to drive the electric motor 7A by the braking control apparatus 17 (or the parking brake control apparatus 32) including the vehicle body-side control apparatus 41 and the brake control apparatus 42 in the above-described manner, and the basic advantageous effects thereof are not especially different from those achieved by the first embodiment and the second embodiment.

More specifically, the third embodiment also detects the vehicle's unexpected start to move based on the information resulting from the wheel speeds (more specifically, the number of wheel speed pulses) instead of detecting the vehicle's unexpected start to move based on the vibration generated on the wheel cylinder, similarly to the first embodiment and the second embodiment. Due to this configuration, the third embodiment can prevent the vehicle's start to move from being erroneously detected. For example, even when the wheel cylinder vibrates along with the user's (the passenger's) getting into/out of the vehicle, loading/unloading the baggage, or the like, the instruction to drive the electric motor 7A (the electric motor driving instruction) is not transmitted from the brake control apparatus 42 to the vehicle body-side control apparatus 41 unless the brake control apparatus 42 receives the information resulting from detecting the wheel speeds (the number of wheel speed pulses) from the vehicle body-side control apparatus 41. As a result, the third embodiment can allow the vehicle's start to move to be detected with improved accuracy.

In addition, the brake control apparatus 42 transmits the instruction to drive the electric motor 7A (the electric motor driving instruction) to the vehicle body-side control apparatus 41 when receiving the information resulting from detecting the wheel speeds regarding the plurality of wheels 2 and 3 (the number of wheel speed pulses) from the vehicle body-side control apparatus 41. In other words, the brake control apparatus 42 monitors the information resulting from detecting the wheel speeds regarding the four front left, front right, rear left, and rear right wheels 2 and 3, and also transmits the instruction to drive the electric motor 7A when receiving the information resulting from detecting the wheel speeds regarding two wheels 2 and 3 among them. Therefore, the third embodiment can enhance the tolerance against noise, and can also allow the vehicle's start to move to be detected with improved accuracy from this aspect. As a result, the third embodiment can allow the vehicle's unexpected start to move to be accurately detected (determined) and allow the required re-clamping (the reapplication) to be performed.

In the third embodiment, the vehicle body-side control apparatus 41 and the brake control apparatus 42 have been described referring to the example when they are configured as one control apparatus (the braking control apparatus 17 or the parking brake control apparatus 32). However, the vehicle body-side control apparatus and the brake control apparatus are not limited thereto, and may be configured to be prepared as individual different control apparatuses and be communicably connected to each other.

Each of the embodiments has been described referring to the example when the hydraulic disk brake equipped with the electric parking brake function is employed as the rear wheel-side disk brake 6, and, along therewith, the hydraulic disk brake unequipped with the electric parking brake function is employed as the front wheel-side disk brake 5. However, the rear wheel-side disk brake 6 and the front wheel-side disk brake 5 are not limited thereto, and, for example, the hydraulic disk brake unequipped with the electric parking brake function may be employed as the rear wheel-side disk brake 6, and, along therewith, the hydraulic disk brake equipped with the electric parking brake function may be employed as the front wheel-side disk brake 5. Alternatively, the hydraulic disk brake equipped with the electric parking brake function may be employed as both the front wheel-side disk brake 5 and the rear wheel-side disk brake 6. In sum, the brakes on at least a pair of left and right wheels, among the wheels of the vehicle, can be realized by the electric parking brake.

In each of the above-described embodiments, the brake mechanism has been described referring to the hydraulic disk brake 6 equipped with the electric parking brake as the brake mechanism by way of example. However, the brake mechanism is not limited to the disk brake-type brake mechanism, and may be configured as a drum brake-type brake mechanism. Further examples of the employable configuration as the electric parking brake include various types of brake mechanisms, such as a drum-in disk brake in which a drum-type electric parking brake is provided in a disk brake, and a configuration that maintains the parking brake by pulling a cable with use of an electric motor.

Further, each of the above-described embodiments is only an example, and it is apparent that the configurations indicated in the different embodiments can be partially replaced or combined.

Possible configurations as the electric brake apparatus, the electric brake control apparatus, and the brake control apparatus based on the above-described embodiments include the following examples.

As a first configuration, an electric brake apparatus includes at least one wheel speed detection portion(s) configured to detect wheel speeds of a plurality of wheels, respectively, an electric motor configured to drive an electric mechanism configured to apply a braking force to a vehicle and also maintain this braking force, and a control apparatus configured to control driving of the electric motor. The control apparatus drives the electric motor to increase the braking force when the wheel speed detection portion(s) detect(s) wheel speed pulses from at least two wheels after a start to maintain the braking force.

According to this first configuration, the electric brake apparatus detects a vehicle's unexpected start to move based on whether the wheel speed pulses are generated or not (i.e., whether the wheel speed pulses are detected or not) instead of detecting the vehicle's unexpected start to move (for example, the vehicle slips back) based on a vibration generated on a wheel cylinder. As a result, the electric brake apparatus can detect a state in which wheels rotate, thereby preventing erroneous detection of the vehicle's start to move. For example, even when the wheel cylinder vibrates along with a user's (a passenger's) getting into/out of the vehicle, loading/unloading baggage, or the like, the electric motor is not driven unless the wheels rotate and the wheel speed pulses are detected. As a result, the present configuration can allow the vehicle's start to move to be detected with improved accuracy. In addition, the electric brake apparatus drives the electric motor when detecting the wheel speed pulses from two wheels among the plurality of wheels. In other words, the electric brake apparatus monitors the wheel speed pulses of the plurality of wheels (for example, four front left, front right, rear left, and rear right wheels) and also drives the electric motor when detecting the wheel speed pulses from two wheels among them. Therefore, the present configuration can enhance tolerance against noise, and can also allow the vehicle's start to move to be detected with improved accuracy from this aspect. As a result, the present configuration can allow the vehicle's unexpected start to move to be accurately detected and allow a required braking force to be applied.

As a second configuration, in the first configuration, the control apparatus drives the electric motor to increase the braking force when the wheel speed detection portion(s) detect(s) the wheel speed pulses from at least one of front wheels and at least one of rear wheels. According to this second configuration, the electric brake apparatus detects the vehicle's unexpected start to move based on the wheel speed pulses generated from at least one wheel of each of the front wheels and the rear wheels instead of detecting the vehicle's unexpected start to move based on the wheel speed pulse generated on only the front wheel or only the rear wheel. In other words, the electric brake apparatus can recognize that the rear wheel rotates by distinguishing the wheel speed pulse generated on each of the wheels between the front and rear sides, instead of using the wheel speed pulses of the four front left, front right, rear left, and rear right wheels without distinguishing them for the detection of the vehicle's start to move. Therefore, the present configuration can prevent the electric motor from being further driven (prevent a thrust force from unintentionally increasing), for example, under a situation that the rear wheel is accidentally locked on a low μ road.

According to a third configuration, in the first or second configuration, the control apparatus drives the electric motor to increase the braking force when the wheel speed detection portion(s) detect(s) the wheel speed pulses from at least two or more wheels after the control apparatus determines that the vehicle is in a stopped state. According to this third configuration, the electric brake apparatus monitors the vehicle's unexpected start to move after the vehicle is brought into the stopped state instead of monitoring the vehicle's unexpected start to move since immediately after the start to maintain the braking force. Therefore, for example, when the braking force starts to be maintained while the vehicle is running, the vehicle's start to move can be detected after the vehicle is stopped. Therefore, for example, when the electric parking brake is used as the emergency brake while the vehicle is running, the present configuration can prevent the electric brake apparatus from erroneously determining the vehicle's start to move by mistaking inertial running before the vehicle is stopped as the vehicle's start to move. Further, the present configuration can prevent the electric brake apparatus from erroneously detecting the vehicle's start to move when the vehicle swings back upon being stopped, by mistaking such a motion as the vehicle's start to move. Therefore, the present configuration can also allow the vehicle's unexpected start to move to be detected with improved accuracy from this aspect.

As a fourth configuration, in the third configuration, the control apparatus determines that the vehicle is in the stopped state when a predetermined time has passed after the start to maintain the braking force. According to this fourth configuration, the electric brake apparatus monitors the vehicle's unexpected start to move after the predetermined time (a predetermined determination mask time) has passed instead of monitoring the vehicle's unexpected start to move since immediately after the start to maintain the braking force. Therefore, the present configuration can prevent the electric brake apparatus from erroneously detecting the vehicle's start to move when the vehicle inertially runs before being stopped or when the vehicle swings back upon being stopped, by mistaking such a motion as the vehicle's start to move.

As a fifth configuration, in the first to third configurations, each of the wheel speed detection portion(s) detects the number of wheel speed pulses during a predetermined period. According to this fifth configuration, the electric brake apparatus can accurately detect the wheel speed pulse (i.e., detect the wheel speed and thus detect the vehicle's start to move).

As a sixth configuration, an electric brake control apparatus acquires wheel speed information from a plurality of wheels and controls driving of an electric motor configured to drive an electric mechanism. The electric mechanism is configured to apply a braking force to a vehicle and also maintain this braking force. The electric brake control apparatus drives the electric motor to increase the braking force when acquiring the wheel speed information regarding at least two wheels after a start to maintain the braking force.

According to this sixth configuration, the electric brake control apparatus detects the vehicle's unexpected start to move based on the wheel speed information (for example, information about the detection of the wheel speed pulse) instead of detecting the vehicle's unexpected start to move based on the vibration generated on the wheel cylinder. Due to this configuration, the electric brake control apparatus can be prevented from erroneously detecting the vehicle's start to move. For example, even when the wheel cylinder vibrates along with the user's (the passenger's) getting into/out of the vehicle, loading/unloading the baggage, or the like, the electric motor is not driven unless the wheel speed information is acquired. As a result, the present configuration can allow the vehicle's start to move to be detected with improved accuracy. In addition, the electric motor is driven when the wheel speed information regarding two wheels among the plurality of wheels is acquired. In other words, the electric brake control apparatus monitors the wheel speed information regarding the plurality of wheels (for example, the four front left, front right, rear left, and rear right wheels) and also drives the electric motor when detecting the wheel speed information from two wheels among them. Therefore, the present configuration can enhance the tolerance against noise, and can also allow the vehicle's start to move to be detected with improved accuracy from this aspect. As a result, the present configuration can allow the vehicle's unexpected start to move to be accurately detected and allow the required braking force to be applied.

As a seventh configuration, in the sixth configuration, the electric brake control apparatus drives the electric motor to increase the braking force when acquiring the wheel speed information regarding at least one of front wheels and at least one of rear wheels. According to this seventh configuration, the electric brake control apparatus detects the vehicle's unexpected start to move based on the wheel speed information regarding at least one wheel of each of the front wheels and the rear wheels instead of detecting the vehicle's unexpected start to move based on the wheel speed information (for example, the information about the detection of the wheel speed pulse) regarding only the front wheel or only the rear wheel. In other words, the electric brake control apparatus can recognize that the rear wheel rotates by distinguishing the wheel speed information of each of the wheels between the front and rear sides, instead of using the wheel speed information of the four front left, front right, rear left, and rear right wheels without distinguishing them for the detection of the vehicle's start to move. Therefore, the present configuration can prevent the electric motor from being further driven (prevent the thrust force from unintentionally increasing), for example, under a situation that the rear wheel is accidentally locked on a low μ road.

According to an eighth configuration, in the sixth or seventh configuration, the electric brake control apparatus drives the electric motor to increase the braking force when acquiring the wheel speed information regarding at least two or more wheels after the electric brake control apparatus determines that the vehicle is in a stopped state. According to this eighth configuration, the electric brake control apparatus monitors the vehicle's unexpected start to move after the vehicle is brought into the stopped state instead of monitoring the vehicle's unexpected start to move since immediately after the start to maintain the braking force. Therefore, for example, when the braking force starts to be maintained while the vehicle is running, the vehicle's start to move can be detected after the vehicle is stopped. Therefore, for example, when the electric parking brake is used as the emergency brake while the vehicle is running, the present configuration can prevent the electric brake control apparatus from erroneously determining the vehicle's start to move by mistaking the inertial running before the vehicle is stopped as the vehicle's start to move. Further, the present configuration can prevent the electric brake control apparatus from erroneously detecting the vehicle's start to move when the vehicle swings back upon being stopped, by mistaking such a motion as the vehicle's start to move. Therefore, the present configuration can also allow the vehicle's unexpected start to move to be detected with improved accuracy from this aspect.

According to a ninth configuration, in the eighth configuration, the electric brake control apparatus determines that the vehicle is in the stopped state when a predetermined time has passed after the start to maintain the braking force. According to this ninth configuration, the electric brake control apparatus monitors the vehicle's unexpected start to move after the predetermined time (the predetermined determination mask time) has passed instead of monitoring the vehicle's unexpected start to move since immediately after the start to maintain the braking force. Therefore, the present configuration can prevent the electric brake control apparatus from erroneously detecting the vehicle's start to move when the vehicle inertially runs before being stopped or when the vehicle swings back upon being stopped, by mistaking such a motion as the vehicle's start to move.

According to a tenth configuration, in the sixth to eighth configurations, the wheel speed information is the number of wheel speed pulses during a predetermined period. According to this tenth configuration, the electric brake control apparatus can accurately acquire the wheel speed information (i.e., detect the wheel speed and thus detect the vehicle's start to move).

According to an eleventh configuration, a brake control apparatus receives wheel speed information acquired from a plurality of wheels from a vehicle body-side control apparatus, and transmits an instruction to drive an electric mechanism to the vehicle body-side control apparatus. The electric mechanism is configured to apply a braking force to a vehicle and also maintain this braking force. The brake control apparatus transmits the instruction to drive the electric motor so as to increase the braking force to the vehicle body-side control apparatus when receiving the wheel speed information resulting from detecting wheel speeds regarding a plurality of wheels from the vehicle body-side control apparatus after transmitting information indicating a transition of the electric mechanism to a braking force maintenance state to the vehicle body-side control apparatus.

According to this eleventh configuration, the brake control apparatus detects the vehicle's unexpected start to move based on the information resulting from detecting the wheel speeds (for example, the number of wheel speed pulses) instead of detecting the vehicle's unexpected start to move based on the vibration generated on the wheel cylinder. Due to this configuration, the brake control apparatus can be prevented from erroneously detecting the vehicle's start to move. For example, even when the wheel cylinder vibrates along with the user's (the passenger's) getting into/out of the vehicle, loading/unloading the baggage, or the like, the instruction to drive the electric motor is not transmitted from the brake control apparatus to the vehicle body-side control apparatus unless the brake control apparatus receives the information resulting from detecting the wheel speeds from the vehicle body-side control apparatus. As a result, the present configuration can allow the vehicle's start to move to be detected with improved accuracy. In addition, the brake control apparatus transmits the instruction to drive the electric motor to the vehicle body-side control apparatus when receiving the information resulting from detecting the wheel speeds regarding the plurality of wheels from the vehicle body-side control apparatus. For example, the brake control apparatus can operate so as to monitor the information resulting from detecting the wheel speeds regarding the plurality of wheels (for example, the four front left, front right, rear left, and rear right wheels), and also transmit the instruction to drive the electric motor when receiving the information resulting from detecting the wheel speeds regarding two wheels among them. Therefore, the present configuration can enhance the tolerance against noise, and can also allow the vehicle's start to move to be detected with improved accuracy from this aspect. As a result, the present configuration can allow the vehicle's unexpected start to move to be accurately detected and the required braking force to be applied.

As a twelfth configuration, in the eleventh configuration, the brake control apparatus transmits the instruction to drive the electric motor so as to increase the braking force to the vehicle body-side control apparatus when receiving the wheel speed information resulting from detecting the wheel speeds regarding at least one of front wheels and at least one of rear wheels. According to this twelfth configuration, the brake control apparatus detects the vehicle's unexpected start to move based on the information resulting from detecting the wheel speeds regarding at least one wheel of each of the front wheels and the rear wheels instead of detecting the vehicle's unexpected start to move based on the information resulting from detecting the wheel speed regarding only the front wheel or only the rear wheel. In other words, the brake control apparatus can recognize that the rear wheel rotates by distinguishing the wheel speed generated on each of the wheels between the front and rear sides, instead of using the wheel speeds of the four front left, front right, rear left, and rear right wheels without distinguishing them for the detection of the vehicle's start to move. Therefore, the present configuration can prevent the electric motor from being further driven (prevent the thrust force from unintentionally increasing), for example, under a situation that the rear wheel is accidentally locked on a low μ road.

As a thirteenth configuration, in the eleventh or twelfth configuration, the brake control apparatus transmits the instruction to drive the electric motor so as to increase the braking force to the vehicle body-side control apparatus when receiving the wheel speed information resulting from detecting the wheel speeds regarding at least two or more wheels after the brake control apparatus determines that the vehicle is in a stopped state. According to this thirteenth configuration, the brake control apparatus monitors the vehicle's unexpected start to move after the vehicle is brought into the stopped state instead of monitoring the vehicle's unexpected start to move since immediately after the start to maintain the braking force. Therefore, for example, when the braking force starts to be maintained while the vehicle is running, the vehicle's start to move can be detected after the vehicle is stopped. Therefore, for example, when the electric parking brake is used as the emergency brake while the vehicle is running, the present configuration can prevent the brake control apparatus from erroneously determining the vehicle's start to move by mistaking the inertial running before the vehicle is stopped as the vehicle's start to move. Further, the present configuration can prevent the brake control apparatus from erroneously detecting the vehicle's start to move when the vehicle swings back upon being stopped, by mistaking such a motion as the vehicle's start to move. Therefore, the present configuration can also allow the vehicle's unexpected start to move to be detected with improved accuracy from this aspect.

According to a fourteenth configuration, in the thirteenth configuration, the brake control apparatus determines that the vehicle is in the stopped state when a predetermined time has passed after the start to maintain the braking force. According to this fourteenth configuration, the brake control apparatus monitors the vehicle's unexpected start to move after the predetermined time (the predetermined determination mask time) has passed instead of monitoring the vehicle's unexpected start to move since immediately after the start to maintain the braking force. Therefore, the present configuration can prevent the brake control apparatus from erroneously detecting the vehicle's start to move when the vehicle inertially runs before being stopped or when the vehicle swings back upon being stopped, by mistaking such a motion as the vehicle's start to move.

According to a fifteenth configuration, in the eleventh to thirteenth configurations, the wheel speed information is the number of wheel speed pulses during a predetermined period. According to this fifteenth configuration, the brake control apparatus can accurately detect the wheel speeds (thus detect the vehicle's start to move).

The present invention is not limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each of the embodiments can also be implemented with another configuration added, deleted, or replaced with respect to a part of the configuration of this embodiment.

The present application claims priority under the Paris Convention to Japanese Patent Application No. 2018-121835 filed on Jun. 27, 2018. The entire disclosure of Japanese Patent Application No. 2018-121835 filed on Jun. 27, 2018 including the specification, the claims, the drawings, and the abstract is incorporated herein by reference in its entirety.

### REFERENCE SIGN LIST

2 front wheel (wheel)

3 rear wheel (wheel)

7A electric motor (electrically-driven motor or electric mechanism)

8 rotation-linear motion conversion mechanism (electric mechanism)

17 braking control apparatus (control apparatus, electric brake control apparatus, vehicle body-side control apparatus, or brake control apparatus)

23 wheel speed sensor (wheel speed detection portion)

32 parking brake control apparatus (control apparatus, electric brake control apparatus, vehicle body-side control apparatus, or brake control apparatus)

41 vehicle body-side control apparatus

42 brake control apparatus

1-15. (canceled)

16. An electric brake apparatus comprising:
at least one wheel speed detection portion(s) configured to detect wheel speeds of a plurality of wheels, respectively;
an electric motor configured to drive an electric mechanism, the electric mechanism being configured to apply a braking force to a vehicle and also maintain this braking force; and
a control apparatus configured to control driving of the electric motor,
wherein the control apparatus drives the electric motor to increase the braking force when the wheel speed detection portion(s) detect(s) wheel speed pulses from at least two wheels after a start to maintain the braking force.

17. The electric brake apparatus according to claim 16, wherein the control apparatus drives the electric motor to increase the braking force when the wheel speed detection portion(s) detect(s) the wheel speed pulses from at least one of front wheels and at least one of rear wheels.

18. The electric brake apparatus according to claim 16, wherein the control apparatus drives the electric motor to increase the braking force when the wheel speed detection portion(s) detect(s) the wheel speed pulses from at least two or more wheels after the control apparatus determines that the vehicle is in a stopped state.

19. The electric brake apparatus according to claim 18, wherein the control apparatus determines that the vehicle is in the stopped state when a predetermined time has passed after the start to maintain the braking force.

20. The electric brake apparatus according to claim 16, wherein each of the wheel speed detection portion(s) detects the number of wheel speed pulses during a predetermined period.

21. An electric brake control apparatus, wherein the electric brake control apparatus acquires wheel speed information from a plurality of wheels and controls driving of an electric motor configured to drive an electric mechanism, the electric mechanism being configured to apply a braking force to a vehicle and also maintain this braking force, and
wherein the electric brake control apparatus drives the electric motor to increase the braking force when acquiring the wheel speed information regarding at least two wheels after a start to maintain the braking force.

22. The electric brake control apparatus according to claim 21, wherein the electric brake control apparatus drives the electric motor to increase the braking force when acquiring the wheel speed information regarding at least one of front wheels and at least one of rear wheels.

23. The electric brake control apparatus according to claim 21, wherein the electric brake control apparatus drives the electric motor to increase the braking force when acquiring the wheel speed information regarding at least two or more wheels after the electric brake control apparatus determines that the vehicle is in a stopped state.

24. The electric brake control apparatus according to claim 23, wherein the electric brake control apparatus determines that the vehicle is in the stopped state when a predetermined time has passed after the start to maintain the braking force.

25. The electric brake control apparatus according to claim 21, wherein the wheel speed information is the number of wheel speed pulses during a predetermined period.

26. A brake control apparatus, wherein the brake control apparatus receives wheel speed information acquired from a plurality of wheels from a vehicle body-side control apparatus, and transmits an instruction to drive an electric mechanism to the vehicle body-side control apparatus, the electric mechanism being configured to apply a braking force to a vehicle and also maintain this braking force, and
wherein the brake control apparatus transmits the instruction to drive an electric motor so as to increase the braking force to the vehicle body-side control apparatus when receiving the wheel speed information resulting from detecting wheel speeds regarding a plurality of wheels from the vehicle body-side control apparatus after transmitting information indicating a transition of the electric mechanism to a braking force maintenance state to the vehicle body-side control apparatus.

27. The brake control apparatus according to claim 26, wherein the brake control apparatus transmits the instruction to drive the electric motor so as to increase the braking force to the vehicle body-side control apparatus when receiving the wheel speed information resulting from detecting the wheel speeds regarding at least one of front wheels and at least one of rear wheels.

28. The brake control apparatus according to claim 26, wherein the brake control apparatus transmits the instruction to drive the electric motor so as to increase the braking force to the vehicle body-side control apparatus when receiving the wheel speed information resulting from detecting the wheel speeds regarding at least two or more wheels after the brake control apparatus determines that the vehicle is in a stopped state.

29. The brake control apparatus according to claim 28, wherein the brake control apparatus determines that the vehicle is in the stopped state when a predetermined time has passed after the start to maintain the braking force.

30. The brake control apparatus according to claim 26, wherein the wheel speed information is the number of wheel speed pulses during a predetermined period.
